(19) United States
(12) Patent Application Publication
(10) Pub. No.: US 2008/0113119 A1
(43) Pub. Date: May 15, 2008

(54) Polarizing Plate And Image Display Apparatus Using The Same

(75) Inventors: Naoki Tsujiuchi, Ibaraki-shi (JP); Akihiro Nishida, Ibaraki-shi (JP); Kanako Wasai, Ibaraki-shi (JP); Naoki Tomoguchi, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 11/667,699

(22) PCT Filed: Oct. 31, 2005
(86) PCT No.: PCT/JP05/19965

§ 371 Date: Oct. 1, 2007

(30) Foreign Application Priority Data
Nov. 18, 2004 (JP) 2004-334690

(51) Int. Cl. C09K 19/00

(52) U.S. Cl. 428/1.31

(57) ABSTRACT

It is an object of the present invention to provide a polarizing plate having excellent adhesive property between a polarizer and a protective film, excellent durability under high temperature and high humidity conditions, and excellent appearance, and an image display apparatus using the polarizing plate. The polarizing plate of the present invention includes a polarizer, an adhesive layer, an adhesion promotion layer, and a protective film formed of a film containing as a main component a cyclic olefin-based resin, in which the adhesion promotion layer contains a silane having a reactive functional group and has a thickness of 1 to 50 nm.

### TECHNICAL FIELD

The present invention relates to a polarizing plate and to an image display apparatus using the same. More specifically, the present invention relates to a polarizing plate having excellent adhesive property between a polarizer and a protective film, excellent durability under high temperature and high humidity conditions, and excellent appearance, and to an image display apparatus using the polarizing plate.

### BACKGROUND ART

A liquid crystal display apparatus as a typical image display apparatus must have polarizing plates arranged on both sides of a liquid crystal cell due to its image forming system. An example of such a polarizing plate to be used is generally produced by: coloring a polyvinyl alcohol (PVA)-based film with a dichromatic substance such as iodine or a dichromatic dye; stretching the film into a polarizer; and attaching a protective film formed of triacetyl cellulose (TAC) or the like on each side of the polarizer by using a PVA-based adhesive.

However, TAC has insufficient heat and humidity resistance and thus has a problem in that properties (such as degree of polarization and color) of a polarizing plate degrade when a polarizing plate including TAC as a protective film is used under high temperature and/or high humidity conditions. Further, a TAC film causes retardation with respect to incident light in an oblique direction. With recent increase in size of a liquid crystal display, effects of the retardation on viewing angle properties are significant.

For solving the problems described above, there is proposed a cyclic polyolefin-based resin instead of TAC as a material for a protective film. The cyclic polyolefin-based film has low moisture permeability, and the film has substantially no retardation in an oblique direction. However, the cyclic polyolefin-based resin has insufficient adhesive property to a PVA-based adhesive.

For solving such problems, there is proposed a method of bonding a protective film formed of a cyclic olefin-based resin and a PVA polarizer through an acrylic adhesive (see Patent Document 1). However, this method requires heat bonding and requires a long period of time for heating. As a result, this method involves problems in that the PVA polarizer changes color and degree of polarization degrades significantly. Further, this method involves problems in that production efficiency is low and a polarizing plate deforms due to a long period of time required for heating. Meanwhile, there are proposed: a polarizing plate protective film including a polyurethane resin layer and a polyvinyl alcohol layer laminated on a thermoplastic saturated norbornene resin film; and a polarizing plate including the protective film and a PVA polarizer which are bonded through a polyvinyl alcohol-based adhesive (see Patent Document 2). However, this polarizing plate has a problem in that there occurs numerous floating and streaks by bonding of the protective film and the PVA polarizer. As a result, an appearance of the polarizing plate to be obtained is not stabilized and an yield is not high. Thus, this polarizing plate has a problem of low productivity.
Patent Document 1: JP 5-212828 A
Patent Document 2: JP 2001-174637 A

### DISCLOSURE OF THE INVENTION

### Problem to be Solved by the Invention

The present invention has been made in view of solving conventional problems as described above, and an object of the present invention is to provide a polarizing plate having excellent adhesive property between a polarizer and a protective film, excellent durability under high temperature and high humidity conditions, and excellent appearance, and an image display apparatus using the polarizing plate.

### Means for solving the Problem

According to one aspect of the present invention, a polarizing plate is provided. The polarizing plate includes a polarizer, an adhesive layer, an adhesion promotion layer, and a protective film formed of a film containing as a main component a cyclic olefin-based resin. The adhesion promotion layer contains a silane having a reactive functional group and has a thickness of 1 to 50 nm.

In one embodiment of the present invention, the silane is one selected from the group consisting of alkoxysilanes each having an isocyanate group, alkoxysilanes each having an amino group, alkoxysilanes each having a mercapto group, alkoxysilanes each having a carboxy group, alkoxysilanes each having an epoxy group, alkoxysilanes each having a vinyl unsaturated group, alkoxysilanes each having a halogen group, and alkoxysilanes each having an isocyanurate group. Preferably, the silane includes alkoxysilanes each having an amino group.

In another embodiment of the present invention, the polarizing plate further includes a second protective film on the polarizer on an opposite side with respect to the protective film. The second protective film is formed of a film containing as a main component triacetyl cellulose.

According to another aspect of the present invention, an image display apparatus is provided. The image display apparatus includes the polarizing plate.

According to still another aspect of the present invention, a liquid crystal display apparatus is provided. The liquid crystal display apparatus includes: a liquid crystal cell; and the polarizing plate arranged on at least one side of the liquid crystal cell. The protective film formed of a film containing as a main component a cyclic olefin-based resin of the polarizing plate is arranged on a side of the liquid crystal cell.

### EFFECTS OF THE INVENTION

As described above, the present invention can provide a polarizing plate having excellent adhesive property between a polarizer and a protective film, excellent durability under high temperature and high humidity conditions, and excellent appearance by forming on a polarizer side of a protective film an adhesion promotion layer containing a silane having a reactive functional group and significantly reducing a thickness of the adhesion promotion layer. Such a finding is acquired for the first time by actually subjecting a polarizing plate including an extremely thin adhesion promotion layer containing a specific silane under high temperature and high humidity conditions, and is an unexpected and excellent effect.

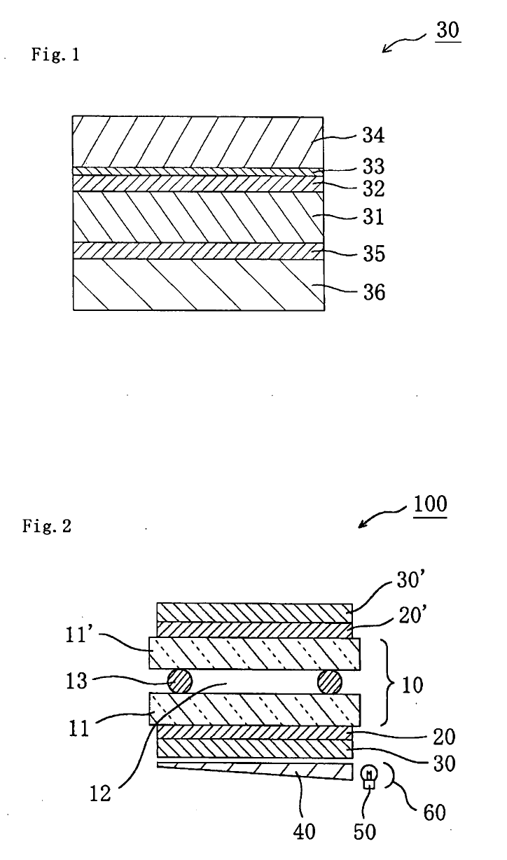

### BRIEF DESCRIPTION OF THE DRAWINGS

[FIG. 1] A schematic sectional view of a polarizing plate according to a preferred embodiment of the present invention.

[FIG. 2] A schematic sectional view of a liquid crystal display apparatus according to a preferred embodiment of the present invention.

### DESCRIPTION OF REFERENCE NUMERALS

10 liquid crystal cell

11, 11′ glass substrate

12 liquid crystal layer

13 spacer

20, 20′ retardation film

30, 30′ polarizing plate

31 polarizer

32 adhesive layer

33 adhesion promotion layer

34 protective film

100 liquid crystal display apparatus

### BEST MODE FOR CARRYING OUT THE INVENTION

Hereinafter, description will be given of preferred embodiments of the present invention, but the present invention is not limited to the embodiments.

A. Polarizing Plate

### A-1. Schematic Structure of Polarizing Plate

FIG. 1 is a schematic sectional view of a polarizing plate according to a preferred embodiment of the present invention. A polarizing plate 30 includes a polarizer 31, an adhesive layer 32, an adhesion promotion layer 33, and a protective film 34 in the order given. For practical use, the polarizing plate 30 may include a second protective film 36 attached to an opposite side of the protective film 34 on the polarizer 31 through the adhesive layer 35.

A-2. Protective Film

The protective film 34 is formed of a film containing as a main component a cyclic olefin-based resin. In the specification of the present invention, the phrase “containing as a main component” indicates that the film includes a cyclic olefin-based resin in a ratio of 50 wt % or more, preferably 60 wt % or more, and more preferably 70 wt % or more of a total weight of the film. The cyclic olefin-based resin is a general term for a polymerized resin of a cyclic olefin as a polymerization unit, and examples thereof include resins described in JP-A-03-14882, JP-A-03-122137, and the like. Specific examples thereof include a ring-opened (co)polymer of a cyclic olefin, an addition polymer of a cyclic olefin, a copolymer (typically, a random copolymer) of a cyclic olefin and an α-olefin such as ethylene or propylene, a graft modified product containing those polymers modified with an unsaturated carboxylic acid or a derivative thereof, and hydrides thereof. A specific example of the cyclic olefin includes a norbornene-based monomer.

Examples of the norbornene-based monomer include: norbornene, alkyl- and/or alkylidene-substituted products thereof such as 5-methyl-2-norbornene, 5-dimethyl-2-norbornene, 5-ethyl-2-norbornene, 5-butyl-2-norbornene, and 5-ethylidene-2-norbornene, and substituted products thereof with a polar group such as halogen; dicyclopentadiene and 2,3-dihydrodicyclopentadiene; dimethanoctahydronaphthalene, alkyl- and/or alkylidene-substituted products thereof, and substituted products thereof with a polar group such as halogen, such as 6-methyl-1,4:5,8-dimethano-1,4,4a,5,6,7,8,8a-octahydronaphthalene, 6-ethyl-1,4:5,8-dimethano-1,4,4a,5,6,7,8,8a-octahydronaphthalene, 6-ethylidene-1,4:5,8-dimethano-1,4,4a,5,6,7,8,8a-octahydronaphthalene, 6-chloro-1,4:5,8-dimethano-1,4,4a,5,6,7,8,8a-octahydronaphthalene, 6-cyano-1,4:5,8-dimethano-1,4,4a,5,6,7,8,8a-octahydronaphthalene, 6-pyridyl-1,4:5,8-dimethano-1,4,4a,5,6,7,8,8a-octahydronaphthalene, and 6-methoxycarbonyl-1,4:5,8-dimethano-1,4,4a,5,6,7,8,8a-octahydronaphthalene; a trimer and a tetramer of cyclopentadiene such as 4,9:5,8-dimethano-3a,4,4a,5,8,8a,9,9a-octahydro-1H-benzoindene and 4,11:5,10:6,9-trimethano-3a,4,4a,5,5a,6,9,9a,10,10a,11,11a-dodecahydro-1H-cyclopentaanthracene.

In the present invention, other cycloolefins allowing ring opening polymerization can be used in combination within a range not inhibiting the purpose of the present invention. A specific example of such a cycloolefin includes a compound having one reactive double bond such as cyclopentene, cyclooctene, or 5,6-dihydrodicyclopentadiene.

The cyclic olefin-based resin has a number average molecular weight (Mn) measured by a gel permeation chromatography (GPC) method by using a toluene solvent of preferably 25,000 to 200,000, more preferably 30,000 to 100,000, and most preferably 40,000 to 80,000. A number average molecular weight within the above ranges can provide a film having excellent mechanical strength and favorable solubility, formability, and operability.

In the case where the cyclic olefin-based resin is obtained through hydrogenation of a ring opened polymer of a norbornene-based monomer, a hydrogenation rate is preferably 90% or more, more preferably 95% or more, and most preferably 99% or more. A hydrogenation rate within the above ranges can provide a film having excellent heat resistance, light resistance, and the like.

Various products of the cyclic olefin-based resin are commercially available. Specific examples thereof include: ZEONEX and ZEONOR, trade names, available from Zeon Corporation; ARTON available from JSR Corporation; and TOPAS available from TICONA.

The protective film 34 may contain any appropriate additive as required. The kind and use amount of the additive may appropriately be set in accordance with the purpose. Specific examples of the additive include a plasticizer, an antioxidant, a tackifier (such as a terpene resin, a phenol resin, a terpene/phenol resin, a rosin resin, or a xylene resin), a UV absorber, and a heat stabilizer.

A thickness of the protective film 34 is typically 500 μm or less, preferably 1 to 300 μm, and more preferably 5 to 200 μm.

A retardation (in-plane retardation) of the protective film 34 is preferably as small as possible because effects on polarization properties of the polarizing plate can be reduced to minimum. Specifically, the retardation is preferably 20 nm or less, more preferably 10 nm or less, and most preferably 5 nm or less.

A light transmittance of the protective film 34 is preferably as large as possible (that is, ideally 100%). For practical use, the light transmittance is preferably 85% or more, more preferably 90% or more, and most preferably 95% or more. A light transmittance of 85% or more can sufficiently assure transmitted light quantity of the polarizing plate and seldom leads to degradation of polarization properties causing problems in practical use.

A water vapor permeation rate of the protective film 34 having a thickness of 25 μm at 70° C. and 90% RH is preferably 300 g/m²·24 hr or less, more preferably 200 g/m²·24 hr or less, and most preferably 100 g/m²·24 hr or less. A water vapor permeation rate within the above ranges can provide a polarizing plate having excellent durability. Meanwhile, the water vapor permeation rate is preferably 0.05 g/m²·24 hr or more, and more preferably 0.1 g/m²·24 hr or more. A water vapor permeation rate within the above ranges allows moisture in the polarizer or the adhesive to sufficiently permeate through the protective film during a drying step in production of the polarizing plate. Thus, problems such as degradation in adhesive property and polarization properties due to residual moisture are seldom caused.

An absolute value of photoelastic coefficient C[590] (m²/N) of the protective film 34 is preferably 2.0×10⁻¹³ to 2.0×10⁻¹¹, more preferably 5.0×10⁻¹³ to 8.0×10⁻¹², particularly preferably 2.0×10⁻¹² to 6.0×10⁻¹², and most preferably 2.0×10⁻¹² to 5.0×10⁻¹². A photoelastic coefficient within the above ranges can suppress display unevenness of an image display apparatus (in particular, a liquid crystal display apparatus) employing the polarizing plate.

A surface of the protective film 34 having no polarizer attached may be subjected to hard coat treatment, antireflection treatment, anti-sticking treatment, or diffusion treatment (also referred to as antiglare treatment). The hard coat treatment is conducted for the purpose of preventing damages on the surface of the polarizing plate and is conducted by forming a cured film having excellent hardness, slip property, and the like with any appropriate UV-curable resin (such as an acrylic or silicone-based resin) on the surface of the protective film. The antireflection treatment is conducted for the purpose of preventing reflection of external light on the surface of the polarizing plate. The anti-sticking treatment is conducted for the purpose of preventing bonding with an adjacent layer. The antiglare treatment is conducted for the purpose of preventing reflection of external light on the surface of the polarizing plate to inhibit visual observation of transmitted light or the like and is conducted by providing a fine uneven structure on a surface of a transparent protective film by any appropriate method (such as a rough surface forming method by a sandblasting method or an embossing method, or a method of mixing transparent fine particles). An antiglare layer (layer formed through the antiglare treatment) may also serve as a diffusion layer for diffusing transmitted light to expand a viewing angle (i.e., a layer having a viewing angle expanding function or the like). Note that such treatment may be conducted on the second protective film 36 (described below) as well.

A-3. Adhesion Promotion Layer

The adhesion promotion layer 33 contains a silane having a reactive functional group. Such an adhesion promotion layer is provided, to thereby significantly improve adhesive property between the polarizer 31 and the protective film 34. Specific examples of the silane having a reactive functional group include: alkoxysilanes each having an isocyanate group such as γ-isocyanatepropyltrimethoxysilane, γ-isocyanatepropyltriethoxysilane, γ-isocyanatepropylmethyldiethoxysilane, and γ-isocyanatepropylmethyldimethoxysilane; alkoxysilanes each having an amino group such as γ-aminopropyltrimethoxysilane, γ-aminopropyltriethoxysilane, γ-aminopropylmethyldimethoxysilane, γ-aminopropylmethyldiethoxysilane, γ-(2-aminoethyl)aminopropyltrimethoxysilane, γ-(2-aminoethyl)aminopropylmethyldimethoxysilane, γ-(2-aminoethyl)aminopropyltriethoxysilane, γ-(2-aminoethyl)aminopropylmethyldiethoxysilane, γ-ureidopropyltrimethoxysilane, N-phenyl-γ-aminopropyltrimethoxysilane, N-benzyl-γ-aminopropyltrimethoxysilane, and N-vinylbenzyl-γ-aminopropyltriethoxysilane; alkoxysilanes each having a mercapto group such as γ-mercaptopropyltrimethoxysilane, γ-mercaptopropyltriethoxysilane, γ-mercaptopropylmethyldimethoxysilane, and γ-mercaptopropylmethyldiethoxysilane; alkoxysilanes each having an epoxy group such as γ-glycidoxypropyltrimethoxysilane, γ-glycidoxypropyltriethoxysilane, γ-glycidoxypropylmethyldimethoxysilane, β-(3,4-epoxycyclohexyl)ethyltrimethoxysilane, and β-(3,4-epoxycyclohexyl)ethyltriethoxysilane; alkoxysilanes each having a carboxy group such as β-carboxyethyltriethoxysilane, β-carboxyethylphenylbis(2-methoxyethoxy)silane, and N-β-(carboxymethyl)aminoethyl-γ-aminopropyltrimethoxysilane; alkoxysilanes each having a vinyl unsaturated group such as vinyltrimethoxysilane, vinyltriethoxysilane, γ-methacryloyloxypropylmethyldimethoxysilane, and γ-acryloyloxypropylmethyltriethoxysilane; alkoxysilanes each having a halogen group such as γ-chloropropyltrimethoxysilane; alkoxysilanes each having an isocyanurate group such as tris(trimethoxysilyl)isocyanurate; and an amino-modified silyl polymer, a silylated amino polymer, an unsaturated aminosilane complex, a phenylamino long chain alkylsilane, aminosilylated silicone, a silylated polyester, and derivatives thereof.

The silane may appropriately be selected in accordance with the kind of protective film, the kind of adhesive to be used for bonding the protective film and the polarizer, and the like. For example, in the case where a water-based adhesive containing PVA is used as an adhesive, preferred examples of the silane include alkoxysilanes each having an amino group such as γ-aminopropyltrimethoxysilane, γ-aminopropyltriethoxysilane, γ-aminopropylmethyldimethoxysilane, γ-aminopropylmethyldiethoxysilane, γ-(2-aminoethyl)aminopropyltrimethoxysilane, γ-(2-aminoethyl)aminopropylmethyldimethoxysilane, γ-(2-aminoethyl)aminopropyltriethoxysilane, γ-(2-aminoethyl)aminopropylmethyldiethoxysilane, γ-ureidopropyltrimethoxysilane, N-phenyl-γ-aminopropyltrimethoxysilane, N-benzyl-γ-aminopropyltrimethoxysilane, and N-vinylbenzyl-γ-aminopropyltriethoxysilane because an adhesion promotion layer having favorable light transmittance, wetness, and adhesive strength is easily formed. Of those, γ-(2-aminoethyl)aminopropyltriethoxysilane and γ-(2-aminoethyl)aminopropylmethyldiethoxysilane are preferred because an adhesion promotion layer having excellent adhesive strength is easily formed.

The thickness of the adhesion promotion layer 33 is 1 to 100 nm, preferably 1 to 50 nm, and more preferably 10 to 50 nm. The thickness of the adhesion promotion layer is adjusted to 100 nm or less. Thus, even in the case where the polarizing plate to be obtained is used under high temperature and high humidity conditions, discoloration, floating, unevenness, and streaks are not caused. That is, a polarizing plate having excellent appearance maintaining ability and excellent degree of polarization maintaining ability under high temperature and high humidity conditions may be obtained. Such a finding is acquired for the first time by actually subjecting a polarizing plate containing a specific silane and including an extremely thin adhesion promotion layer under high temperature and high humidity conditions, and is an unexpected and excellent effect.

### A-4. Adhesive Layer

An adhesive used for forming the adhesive layer 32 may employ any appropriate adhesive as long as it is capable of bonding the protective film 34 and the polarizer 31 favorably. Preferably, an adhesive having optical isotropy may be used. Examples of such an adhesive include a polyvinyl alcohol (PVA)-based adhesive, a urethane-based adhesive, an acrylic adhesive, and an epoxy-based adhesive. For example, in the case where the polarizer is formed of a PVA-based film, an adhesive containing a PVA-based resin is preferred because of excellent adhesive property to the polarizer. The PVA-based resin may employ any appropriate PVA-based resin. Typical examples of the PVA-based resin include unsubstituted PVA and PVA having a highly reactive functional group. PVA having a highly reactive functional group is particularly preferred because durability of the polarizing plate may significantly improve. A specific example of PVA having a highly reactive functional group includes a PVA resin modified with an acetoacetyl group. A degree of polymerization of a binder resin (such as a PVA resin) of the adhesive is preferably 100 to 3,000. A binder resin having a degree of polymerization within the above ranges can provide particularly favorable adhesive property between the polarizer and the protective film. The thickness of the adhesive layer 32 may appropriately be set in accordance with the purpose and application of LCD employing the polarizing plate, but is preferably 30 to 300 nm, and more preferably 50 to 150 nm.

Preferably, the adhesive used for forming the adhesive layer further contains a crosslinking agent. A binder resin and a crosslinking agent are used in combination, to thereby significantly improve adhesive property and water resistance. Specific examples of the crosslinking agent to be used in the present invention include: dialdehydes such as glyoxal, malondialdehyde, succindialdehyde, glutardialdehyde, maleindialdehyde, and phthaldialdehyde, and preferably glyoxal; alkylene diamines each having an alkylene group and two amino groups such as ethylene diamine, triethylene diamine, and hexamethylene diamine, and preferably hexamethylene diamine; isocyanates such as tolylene diisocyanate, hydrogenated tolylene diisocyanate, a trimethylolpropane/tolylene diisocyanate adduct, triphenylmethane trilsocyanate, methylenebis(4-phenylmethane triisocyanate), isophorone diisocyanate, a ketoxime block product thereof, and a phenol block product thereof; epoxides such as ethylene glycol diglycidyl ether, polyethylene glycol diglycidyl ether, glycerin, di or triglycidyl ether, 1,6-hexanediol diglycidyl ether, trimethylolpropane triglycidyl ether, diglycidyl aniline, and diglycidyl amine; monoaldehydes such as formaldehyde, acetaldehyde, propionaldehyde, and butylaldehyde; an amino/formaldehyde resin such as alkylated methylol urea, alkylated methylol melamine, acetoguanamine, or a condensate of benzoguanamine and formaldehyde, and preferably alkylated methylol melamine; and a salt of a divalent metal or trivalent metal such as sodium, potassium, magnesium, calcium, aluminum, iron, or nickel, and oxides thereof. The crosslinking agent is preferably used in a ratio of 0.1 to 30 parts by weight with respect to 100 parts by weight of the binder resin. A use amount thereof of less than 0.1 part by weight may not sufficiently improve water resistance. A use amount thereof of more than 30 parts by weight may shorten a usable life and may not provide excellent adhesive property.

A-5. Polarizer

The polarizer 31 may employ any appropriate polarizer within a range not inhibiting the effects of the present invention. The polarizer to be used is generally produced by: coloring a polymer film with a dichromatic substance (typically, iodine or a dichromatic dye); and uniaxially stretching the film. The polymer film used for forming the polarizer may employ any appropriate polymer film. Typical examples of the polymer film include a polyvinyl alcohol (PVA)-based film, a polyethylene terephthalate (PET)-based film, and an ethylene/vinyl acetate copolymer film. A PVA-based film is preferred because of excellent coloring property with the dichromatic substance. The degree of polymerization of the polymer used for forming the polymer film is preferably 100 to 5,000, and more preferably 1,400 to 4,000. The polymer film used for forming the polarizer may be formed by any appropriate method (such as a flow casting method involving film formation through flow casting of a solution containing a resin dissolved in water or an organic solvent, a casting method, or an extrusion method). The thickness of the polarizer may appropriately be set in accordance with the purpose and application of LCD employing the polarizing plate, but is typically 5 to 80 μm.

A-6. Second Protective Film

The second protective film 36 may employ any appropriate protective film within the range not inhibiting the effects of the present invention. Specific examples of a material used for forming the second protective film 36 include a cellulose-based polymer (such as diacetyl cellulose or triacetyl cellulose), an acrylic polymer (such as polymethyl methacrylate), a styrene-based polymer (such as polystyrene or an acrylonitrile/styrene copolymer (AS resin)), a sulfone-based polymer, a polyethersulfone-based polymer, a polyether ether ketone-based polymer, a polyphenylene sulfide-based polymer, a vinyl alcohol-based polymer, a vinylidene chloride-based polymer, a vinyl butyral-based polymer, a polyoxymethylene-based polymer, and an epoxy-based polymer. Such a polymer may be used alone, or two or more kinds thereof may be used in combination. Further, a film formed of an acrylic, urethane-based, epoxy-based, silicone-based, etc. thermosetting or UV-curable resin may be used. The same protective film as that for the protective film 34 described in the above section A-2 may be used. A cellulose-based polymer film is preferred, and a triacetyl cellulose (TAC) film is particularly preferred. Such a protective film is used as the second protective film 36, to thereby further improve appearance maintaining ability and degree of polarization maintaining ability under high temperature and high humidity conditions. The TAC film has a moderate water vapor permeation rate (that is, a higher water vapor permeation rate than that of a cyclic olefin-based resin). Thus, evaporation of moisture in a production step of the polarizing plate is favorable, and undesired moisture is favorably removed at completion of the polarizing plate. That is, the protective film 34 formed of a cyclic olefin-based resin is used on one side of the polarizer, and the protective film 36 formed of TAC is used on another side of the polarizer, to thereby provide a polarizing plate capable of favorably preventing infiltration of moisture from an external part and capable of favorably discharging undesired moisture in an internal part. The thickness of the second protective film 36 is typically 500 μm or less, preferably 1 to 300 μm, and more preferably 5 to 200 μm. Note that the adhesive layer 35 used for bonding the second protective film 36 and the polarizer 31 may be formed of any appropriate adhesive. For example, the adhesive used for forming the adhesive layer 32 may be used. The adhesives used for forming the adhesive layer 35 and the adhesive layer 32 may be identical to or different from each other. A surface of the second protective film 36 to be attached with the adhesive layer 35 may have an adhesion promotion layer formed thereon. The adhesion promotion layer may be formed of any appropriate material. For example, the material used for forming the adhesion promotion layer 33 may be used. The materials used for forming the adhesion promotion layer and the adhesion promotion layer 33 may be identical to or different from each other.

A-7. Method of Producing Polarizing Plate

Hereinafter, description will be given of a preferred example of a method of producing a polarizing plate of the present invention. First, the polarizer 31 is produced. A method of producing a polarizer may employ any appropriate method in accordance with the purpose, materials to be used, conditions, and the like. Typically, the method employs a method of subjecting a polymer film (such as a PVA-based film) to a series of production steps including swelling, coloring, crosslinking, stretching, water washing, and drying steps. In each treatment step excluding the drying step, the polymer film is immersed in a bath containing a solution to be used in each step for treatment. The order, number of times, and absence or presence of swelling, coloring, crosslinking, stretching, water washing, and drying steps may appropriately be set in accordance with the purpose, materials to be used, conditions, and the like. For example, several treatments may be conducted at the same time in one step, or specific treatments may be omitted. More specifically, stretching treatment, for example, may be conducted after coloring treatment, before coloring treatment, or at the same time as swelling treatment, coloring treatment, and crosslinking treatment. For example, crosslinking treatment is preferably conducted before or after stretching treatment. For example, water washing treatment may be conducted after each treatment or after specific treatments.

The swelling step is typically conducted by immersing the polymer film in a treatment bath (swelling bath) filled with water. This treatment allows washing away of contaminants on a surface of the polymer film, washing away of an anti-blocking agent, and swelling of the polymer film, to thereby prevent non-uniformity such as uneven coloring or the like. The swelling bath may appropriately contain glycerin, potassium iodide, or the like added. A temperature of the swelling bath is typically about 20 to 60° C., and an immersion time in the swelling bath is typically about 0.1 to 10 minutes.

The coloring step is typically conducted by immersing the polymer film in a treatment bath (coloring bath) containing a dichromatic substance such as iodine. As a solvent to be used for a solution of the coloring bath, water is generally used, but an appropriate amount of an organic solvent having compatibility with water may be added. The dichromatic substance is typically used in a ratio of 0.1 to 1.0 part by weight with respect to 100 parts by weight of the solvent. In the case where iodine is used as a dichromatic substance, the solution of the coloring bath preferably further contains an assistant such as an iodide for improving a coloring efficiency. The assistant is used in a ratio of preferably 0.02 to 20 parts by weight, and more preferably 2 to 10 parts by weight with respect to 100 parts by weight of the solvent. Specific examples of the iodide include potassium iodide, lithium iodide, sodium iodide, zinc iodide, aluminum iodide, lead iodide, copper iodide, barium iodide, calcium iodide, tin iodide, and titanium iodide. The temperature of the coloring bath is typically about 20 to 70° C., and the immersion time in the coloring bath is typically about 1 to 20 minutes.

The crosslinking step is typically conducted by immersing the polymer film subjected to the coloring treatment in a treatment bath (crosslinking bath) containing a crosslinking agent. The crosslinking agent may employ any appropriate crosslinking agent. Specific examples of the crosslinking agent include: a boron compound such as boric acid or borax; glyoxal; and glutaraldehyde. The crosslinking agent may be used alone, or used in combination. As a solvent to be used for a solution of the crosslinking bath, water is generally used, but an appropriate amount of an organic solvent having compatibility with water may be added. The crosslinking agent is typically used in a ratio of 1 to 10 parts by weight with respect to 100 parts by weight of the solvent. In the case where a concentration of the crosslinking agent is less than 1 part by weight, sufficient optical properties are often not obtained. In the case where the concentration of the crosslinking agent is more than 10 parts by weight, stretching force to be generated on the film during stretching increases and a polarizing plate to be obtained may shrink. The solution of the crosslinking bath preferably further contains an assistant such as an iodide for obtaining uniform properties in the plane of the film. The concentration of the assistant is preferably 0.05 to 15 wt %, and more preferably 0.5 to 8 wt %. Specific examples of the iodide are the same as those for the coloring step. The temperature of the crosslinking bath is typically about 20 to 70° C., and preferably 40 to 60° C. The immersion time in the crosslinking bath is typically about 1 second to 15 minutes, and preferably 5 seconds to 10 minutes.

The stretching step may be conducted at any time as described above. Specifically, the stretching step may be conducted after the coloring treatment, before the coloring treatment, at the same time as the swelling treatment, the coloring treatment, and the crosslinking treatment, or after the crosslinking treatment. A cumulative stretching ratio of the polymer film is 5 times or more, preferably 5 to 7 times, and more preferably 5 to 6.5 times. In the case where the cumulative stretching ratio is less than 5 times, a polarizing plate having a high degree of polarization may be hardly obtained. In the case where the cumulative stretching ratio is more than 7 times, the polymer film (polarizer) may easily break. A specific method of stretching may employ any appropriate method. For example, in the case where a wet stretching method is employed, a polymer film is stretched in a treatment bath (stretching bath) to a predetermined ratio. A solution of the stretching bath to be preferably used is a solution containing various metal salts or compounds of iodine, boron, or zinc added to a solvent such as water or an organic solvent (such as ethanol).

The water washing step is typically conduced by immersing the polymer film subjected to the various treatments in a treatment bath (water washing bath). The water washing step allows washing away of unnecessary remains of the polymer film. The water washing bath may contain pure water or an aqueous solution containing iodide (such as potassium iodide or sodium iodide). The concentration of an aqueous iodide solution is preferably 0.1 to 10 wt %. The aqueous iodide solution may contain an assistant such as zinc sulfate or zinc chloride. The temperature of the water washing bath is preferably 10 to 60° C., and more preferably 30 to 40° C., and the immersion time is typically 1 second to 1 minute. The water washing step may be conducted only once, or may be conducted a plurality of times as required. In the case where the water washing step is conducted a plurality of times, the kind and concentration of the additive included in the water washing bath to be used for each treatment may appropriately be adjusted. For example, the water washing step includes a step of immersing a polymer film in an aqueous potassium iodide solution (0.1 to 10 wt %, 10 to 60° C.) for 1 second to 1 minute and a step of washing the polymer film with pure water.

The drying step may employ any appropriate drying method (such as natural drying, air drying, or heat drying). For example, in heat drying, a drying temperature is typically 20 to 80° C., and a drying time is typically 1 to 10 minutes. As described above, the polarizer 31 is obtained.

Meanwhile, the protective film 34 is prepared. The protective film 34 is formed by any appropriate method by using a cyclic olefin-based resin described in the above section A-2. Specific examples of a method of forming a protective film include a solution flow casting method, an extrusion method, and a calendering method. Alternately, a commercially available cyclic olefin-based resin film may be used as the protective film 34.

Next, the adhesion promotion layer 33 is formed on the protective film 34. Typically, the adhesion promotion layer 33 is formed by applying to the surface of the protective film the solution containing a silane dissolved in a solvent and described in the above section A-3 or a dispersion containing a silane dispersed in a dispersion medium and described in the above section A-3, and drying the whole. Examples of the solvent or the dispersion medium include water or an organic solvent. The organic solvent is preferably capable of uniformly dissolving or dispersing a silane and has appropriate volatility. Specific examples of such an organic solvent include: alcohols such as methanol, ethanol, and propyl alcohol; ketones such as acetone and methyl ethyl ketone; aromatic hydrocarbons such as benzene, toluene, and xylene; and halogenated hydrocarbons such as methylene chloride and chloroform. The organic solvent may be used alone, or two or more kinds thereof may be used in combination. In the case where a PVA-based adhesive is used for the adhesive layer 32, methanol, ethanol, propyl alcohol, toluene, or a mixed solvent thereof is preferred. The concentration of a silane solution or dispersion may employ any appropriate concentration allowing formation of an adhesion promotion layer, but is typically 10 to 70 wt %.

The method of applying the silane solution or dispersion to the protective film may employ any appropriate method. Specific examples thereof include a gravure coating method, a dip coating method, a spray coating method, and a flow casting method. Examples of the method of drying an application liquid include natural drying and heat treatment. A heating time in the heat treatment is preferably 20° C. or higher and Tg of the protective film or lower, and more preferably 80 to 130° C. A heating time may vary depending on the heating temperature, but is preferably 30 seconds to 1 hour, and more preferably 1 minute to 10 minutes.

As required, the surface of the protective film may be subjected to any appropriate surface treatment before application of the silane solution or dispersion. Specific examples of the surface treatment include corona discharge treatment, glow discharge treatment, primer treatment, coating treatment, and chemical treatment. As described above, the protective film 34 having the adhesion promotion layer 33 formed thereon is obtained.

Finally, the polarizer 31 and the protective film 34 are attached together through an adhesive (eventually, the adhesive layer 32), to thereby obtain a polarizing plate. In this case, the polarizer 31 and the protective film 34 are attached together such that the adhesion promotion layer 33 and the adhesive layer 32 are adjacent to each other. On a surface of the polarizer having no protective film attached, the second protective film 36 is generally attached through an adhesive (adhesive layer 35). Note that a method of attaching the polarizer and the protective film may employ any appropriate method.

On one side or both sides of the polarizing plate obtained as described above, a pressure-sensitive adhesive layer may be provided. A pressure-sensitive adhesive used for forming the pressure-sensitive adhesive layer may employ any appropriate pressure-sensitive adhesive. Examples thereof include an acrylic pressure-sensitive adhesive, a silicone-based pressure-sensitive adhesive, and a rubber-based pressure-sensitive adhesive. Of those, an acrylic pressure-sensitive adhesive is preferred because of high optical transparency and favorable adhesive property to a liquid crystal cell or the like. For practical use, a surface of the pressure-sensitive adhesive layer is covered with any appropriate separator until the polarizing plate is attached to a retardation film, an image display apparatus, or the like described below, to thereby prevent contamination. For example, the separator may be formed by a method of providing a release coat of a silicone-based, long chain alkyl-based, fluorine-based releasing agent, a molybdenum sulfide releasing agent, or the like to any appropriate film as required.

B. Image Display Apparatus

Next, an image display apparatus of the present invention will be described. Description will be given of a liquid crystal display apparatus as an example, but the present invention may obviously be applied to any display apparatus requiring a polarizing plate. A specific example of an image display apparatus to which the polarizing plate of the present invention can be applied includes a self-luminous display apparatus such as an electroluminescence (EL) display, a plasma display (PD), or a field emission display (FED). FIG. 2 is a schematic sectional view of a liquid crystal display apparatus according to a preferred embodiment of the present invention. In the example shown in the figure, description will be given of a transmissive liquid crystal display apparatus, but the present invention may obviously be applied to a reflective liquid crystal display apparatus or the like.

A liquid crystal display apparatus 100 is provided with: a liquid crystal cell 10; retardation films 20 and 20′ arranged to sandwich the liquid crystal cell 10; polarizing plates 30 and 30′ arranged on outer sides of the retardation films 20 and 20′; a light guide plate 40; a light source 50; and a reflector 60. The polarizing plates 30 and 30′ are arranged such that respective absorption axes are perpendicular to each other. The liquid crystal cell 10 includes: a pair of glass substrate 11 and 11′; and a liquid crystal layer 12 as a display medium arranged between the substrates. One substrate 11 is provided with a switching element (typically, TFT) for controlling electrooptic properties of liquid crystals, a scanning line for providing a gate signal to this active element, and a signal line for providing a source signal to the active element (all not shown). The other glass substrate 11′ is provided with a color layer forming a color filter and a shielding layer (black matrix layer) (both not shown). A distance (cell gap) between the substrates 11 and 11′ is controlled by a spacer 13. In the liquid crystal display apparatus of the present invention, the polarizing plate described in the above section A is employed as at least one of the polarizing plates 30 and 30′.

In the polarizing plate described in the above section A, the protective film 34 is preferably arranged on a liquid crystal cell 10 side. Such arrangement allows suppression in display unevenness of a liquid crystal display apparatus and significant improvement in viewing angle properties, due to the protective film 34 having a small photoelastic coefficient and a small retardation. Note that as described above, in the case where the pressure-sensitive adhesive layer is formed on the surface of the protective film 34, the protective film 34 is attached to a liquid crystal cell side through the pressure-sensitive adhesive layer.

In the liquid crystal display apparatus 100 employing TN mode, liquid crystal molecules of the liquid crystal layer 12 are aligned in a state with respective polarization axes shifted by at 90° during application of no voltage. In such a state, incident light including light in one direction transmitted through the polarizing plate is twisted by 90° by the liquid crystal molecules. As described above, the polarizing plates are arranged such that the respective polarization axes are perpendicular to each other, and thus light (polarized light) reaching the other polarizing plate transmits through the polarizing plate. Thus, during application of no voltage, the liquid crystal display apparatus 100 provides a white display (normally white mode). Meanwhile, in the case where a voltage is applied to the liquid crystal display apparatus 100, alignment of the liquid crystal molecules in the liquid crystal layer 12 changes. As a result, the light (polarized light) reaching the other polarizing plate cannot transmit through the polarizing plate, and a black display is provided. Displays are switched as described above by pixel by using the active element, to thereby form an image.

Hereinafter, the present invention will be described by way of examples, but the present invention is not limited to the examples. Note that unless otherwise noted, parts and % in the examples refer to parts by weight and wt %. Evaluation items in the examples are described below.

(1) Adhesive State Between Polarizer and Protective Film

A manual peeling test was conducted for a polarizer and a protective film attached together. A case where the polarizer and the protective film were favorably bonded after the test was indicated by o, and a case where the polarizer and the protective film were peeled was indicated by x.
(2) Durability

The polarizing plate was placed in an environment of 60° C. and 90% RH or 100% RH, and a time until discoloration, unevenness, or floating was observed was measured. Note that the terms “discoloration” and “unevenness” indicate states where no black display was provided when the polarizing plates were arranged in Cross-Nicol arrangement. The term “floating” indicates a state where the polarizer and the protective film were not bonded. The term “streaks” indicates a state where the protective film and/or the polarizer were bonded by themselves in an extremely small area.

### REFERENCE EXAMPLE 1

### Production of Polarizer

A polyvinyl alcohol film (available from Kuraray Co., Ltd.) having a thickness of 80 μm was colored in a 5% aqueous iodide solution (weight ratio of iodine (I)/potassium iodide (KI))=1/10) by adjusting a coloring time such that a polarizer has a predetermined single axis transmittance (43% in this case), immersed in a 3% boric acid+2% KI aqueous solution for 10 seconds, stretched in a 4% boric acid+3% KI aqueous solution to a stretching ratio of 5.5 times, and finally immersed in a 5% KI aqueous solution for 10 seconds. The obtained stretched film was dried in an oven at 40° C. for 3 minutes, to thereby obtain a polarizer having a thickness of 30 μm.

### REFERENCE EXAMPLE 2

### Production of Protective Film Having Adhesion Promotion Layer

A surface of a cyclic olefin-based resin film (available from Zeon Corporation, trade name: ZEONOR, thickness: 40 μm) was subjected to corona treatment. 67 parts of isopropyl alcohol was mixed with 100 parts of a silane (available from Nippon Unicar Co., Ltd., trade name: APZ6601) represented by a chemical formula NH₂CH₂NHCH₂CH₂Si(OC₂H₅)₃, to thereby prepare a 60% silane solution. A predetermined amount of the silane solution was applied to a corona treated surface of the cyclic olefin-based resin film, and the whole was dried at 120° C. for 2 minutes, to thereby obtain a protective film 1 having an adhesion promotion layer. The thickness of the adhesion promotion layer after drying was 30 nm. Note that the thickness of the adhesion promotion layer was adjusted by changing the application amount of the silane solution.

### REFERENCE EXAMPLE 3

### Production of Protective Film Having Adhesion Promotion Layer

A protective film 2 was produced in the same manner as in Reference Example 2 except that the thickness of the adhesion promotion layer after drying was changed to 300 nm.

### EXAMPLE 1

The protective film 1 was attached to one side of the polarizer obtained in Reference Example 1 through a PVA-based adhesive such that the adhesion promotion layer was arranged on a polarizer side. At the same time, a TAC film (available from Fujifilm Corporation, trade name: FUJITAC UV80) subjected to saponification treatment was attached to another side of the polarizer through the PVA-based adhesive. After attachment, the whole was dried at 70° C. for 10 minutes, to thereby obtain a polarizing plate. The obtained polarizing plate was subjected to adhesive state evaluation and durability evaluation. Table 1 shows the results together with results of Example 2 and Comparative Examples 1 and 2 described below.

TABLE 1

| | | Durability | |
|---|---|---|---|
| | Adhesive state | 60° C., 90% RH | 100% RH |
| Example 1 | ◯ | 240 hr or more | 120 hr |
| Example 2 | ◯ | 240 hr or more | 240 hr or more |
| Comparative | X | 100 hr | 100 hr |
| example 1 | | | |
| Comparative | X | 100 hr | 100 hr |
| example 2 | | | |

### EXAMPLE 2

A polarizing plate was obtained in the same manner as in Example 1 except that an acetoacetyl group-modified PVA-based adhesive was used instead of the PVA adhesive for attachment. The obtained polarizing plate was subjected to evaluation in the same manner as in Example 1. Table 1 shows the results.

### COMPARATIVE EXAMPLE 1

A polarizing plate was obtained in the same manner as in Example 1 except that the protective film 2 was used instead of the protective film 1. The obtained polarizing plate was subjected to evaluation in the same manner as in Example 1. Table 1 shows the results.

### COMPARATIVE EXAMPLE 2

A polarizing plate was obtained in the same manner as in Example 2 except that the protective film 2 was used instead of the protective film 1. The obtained polarizing plate was subjected to evaluation in the same manner as in Example 1. Table 1 shows the results thereof.

Table 1 reveals that the polarizing plate of the present invention had excellent adhesive property between the polarizer and the protective film. As a result, the polarizing plate of the present invention had excellent durability (appearance maintaining ability and degree of polarization maintaining ability) under high temperature and high humidity conditions. That is, reduction in thickness of the adhesion promotion layer allowed significant improvement in both adhesive property and durability.

### INDUSTRIAL APPLICABILITY

The polarizing plate of the present invention may suitably be used for an image display apparatus such as a liquid crystal display apparatus (LCD) or a self-luminous display apparatus.

1. A polarizing plate comprising a polarizer, an adhesive layer, an adhesion promotion layer, and a protective film formed of a film containing as a main component a cyclic olefin-based resin, wherein
the adhesion promotion layer contains a silane having a reactive functional group and has a thickness of 1 to 50 nm.

2. A polarizing plate according to claim 1, wherein the silane is one selected from the group consisting of alkoxysilanes each having an isocyanate group, alkoxysilanes each having an amino group, alkoxysilanes each having a mercapto group, alkoxysilanes each having a carboxy group, alkoxysilanes each having an epoxy group, alkoxysilanes each having a vinyl unsaturated group, alkoxysilanes each having a halogen group, and alkoxysilanes each having an isocyanurate group.

3. A polarizing plate according to claim 2, wherein the silane comprises alkoxysilanes each having an amino group.

4. A polarizing plate according to claim 1 further comprising a second protective film on the polarizer on an opposite side with respect to the protective film, wherein the second protective film is formed of a film containing as a main component triacetyl cellulose.

5. An image display apparatus comprising the polarizing plate according to claim 1.

6. A liquid crystal display apparatus comprising: a liquid crystal cell; and the polarizing plate according to claim 1 arranged on at least one side of the liquid crystal cell, wherein
a protective film formed of a film containing as a main component a cyclic olefin-based resin of the polarizing plate is arranged on a side of the liquid crystal cell.

7. A polarizing plate according to claim 2 further comprising a second protective film on the polarizer on an opposite side with respect to the protective film, wherein the second protective film is formed of a film containing as a main component triacetyl cellulose.

8. A polarizing plate according to claim 3 further comprising a second protective film on the polarizer on an opposite side with respect to the protective film, wherein the second protective film is formed of a film containing as a main component triacetyl cellulose.

9. An image display apparatus comprising the polarizing plate according to claim 2.

10. An image display apparatus comprising the polarizing plate according to claim 3.

11. An image display apparatus comprising the polarizing plate according to claim 4.

12. An image display apparatus comprising the polarizing plate according to claim 7.

13. An image display apparatus comprising the polarizing plate according to claim 8.

14. A liquid crystal display apparatus comprising: a liquid crystal cell; and the polarizing plate according to claim 2 arranged on at least one side of the liquid crystal cell, wherein
a protective film formed of a film containing as a main component a cyclic olefin-based resin of the polarizing plate is arranged on a side of the liquid crystal cell.

15. A liquid crystal display apparatus comprising: a liquid crystal cell; and the polarizing plate according to claim 3 arranged on at least one side of the liquid crystal cell, wherein
a protective film formed of a film containing as a main component a cyclic olefin-based resin of the polarizing plate is arranged on a side of the liquid crystal cell.

16. A liquid crystal display apparatus comprising: a liquid crystal cell; and the polarizing plate according to claim 4 arranged on at least one side of the liquid crystal cell, wherein
a protective film formed of a film containing as a main component a cyclic olefin-based resin of the polarizing plate is arranged on a side of the liquid crystal cell.

17. A liquid crystal display apparatus comprising: a liquid crystal cell; and the polarizing plate according to claim 7 arranged on at least one side of the liquid crystal cell, wherein
a protective film formed of a film containing as a main component a cyclic olefin-based resin of the polarizing plate is arranged on a side of the liquid crystal cell.

18. A liquid crystal display apparatus comprising: a liquid crystal cell; and the polarizing plate according to claim 8 arranged on at least one side of the liquid crystal cell, wherein
a protective film formed of a film containing as a main component a cyclic olefin-based resin of the polarizing plate is arranged on a side of the liquid crystal cell.
